(19) United States
(12) Patent Application Publication
(10) Pub. No.: US 2025/0266449 A1
(43) Pub. Date: Aug. 21, 2025

(54) HIGH ENTROPY MXENES AND METHODS OF MAKING THEREOF

(71) Applicant: The Trustees of Indiana University, Bloomington, IN (US)

(72) Inventors: Babak Anasori, Fishers, IN (US); Weichen Hong, Indianapolis, IN (US); Srinivasa Kartik Nemani, Bloomington, IN (US)

(21) Appl. No.: 19/040,334

(22) Filed: Jan. 29, 2025

Related U.S. Application Data
(63) Continuation of application No. 17/497,026, filed on Oct. 8, 2021.
(60) Provisional application No. 63/089,811, filed on Oct. 9, 2020.

(51) Int. Cl. H01M 4/58; C01B 32/907; C22C 1/051; C22C 1/06; C22C 29/02

(52) U.S. Cl. CPC H01M 4/58; C01B 32/907; C22C 1/051; C22C 1/06; C22C 29/02; C01P 2002/72; C01P 2002/77; C01P 2002/85; C01P 2002/88; C01P 2004/03; C01P 2004/04; C01P 2004/24; C01P 2006/40; C22C 2202/02

(57) ABSTRACT

A Composition of matter defined by the general formula of M1M2M3M4X₃ wherein: X is carbon; and M1, M2, M3, and M4 each represent a different transition metal selected from the group consisting of Ti, Ta, Sc, Cr, Zr, Hf, Mo, V, and Nb.

### RELATED APPLICATIONS

The present application is a continuation of U.S. patent application Ser. No. 17/497,026 filed on Oct. 8, 2021, which claims priority to U.S. Provisional Application Ser./N 63/089,811, filed on Oct. 9, 2020, the entire disclosure of which being hereby expressly incorporated herein by reference.

### GOVERNMENT RIGHTS

None.

### TECHNICAL FIELD

Aspects of this disclosure relate to rechargeable battery technologies. More specifically, embodiments relate to carbide materials capable of accommodating ions and molecules during intercalation.

### BACKGROUND

Battery technologies have been considered as the key to realization of long range electric vehicles and efficient large scale grid storage applications. Despite the great progress in research on advanced battery technologies, challenges still exist to increase the energy and powder densities, reduce the cost, and improve the safety and life of the batteries. Of the new electrode materials, two-dimensional (2D) solids are of particular interest due to their large areas of electrochemically-active surfaces. Having a new family of 2D structures with a wide range of chemistries can provide a source of materials for various applications.

### SUMMARY

According to one embodiment, the present disclosure provides a composition of matter defined by the general formula of M1M2M3M4X₃, wherein: X is carbon; and M1, M2, M3, and M4 each represent a different transition metal selected from the group consisting of Ti, Ta, Sc, Cr, Zr, Hf, Mo, V, and Nb. In one aspect of this embodiment, M1, M2, M3, M4 each represent a different transition metal selected from the group consisting of Ti, Ta, Cr, Mo, V, and Nb. In yet another aspect of this embodiment, the composition is selected from the group consisting of TiVNbMoC₃ and TiVCrMoC₃. In another aspect of this embodiment, the composition is a MXene. In yet another aspect of this embodiment, the composition is produced by at least: preparing precursor MAX phase powder; etching the MAX phase powder to obtain multi-layered MXene powder; and delaminating the multi-layered MXene powder to obtain single-to-few-layered MXene flakes. In another aspect of this embodiment, preparing precursor MAX phase powder includes mixing and reactive sintering elemental powders of equimolar ratio of four transition metals M1, M2, M3, and M4 with Al and C M1:M2:M3:M4:Al:C in 1:1:1:1:1.1:2.7 stoichiometric ratio to obtain one or more sintered MAX phase blocks. In yet another aspect of this embodiment, preparing precursor MAX phase powder further includes milling the one or more sintered MAX phase blocks to obtain the MAX phase powder. In a variant aspect of this embodiment, etching the MAX phase powder includes adding the MAX phase powder into an aqueous hydrofluoric acid to selectively etch away Al to obtain multi-layered MXene powder. In a variant aspect of this embodiment, delaminating the multi-layered MXene powder includes delaminating the multi-layered MXene powder using tetramethylammonium hydroxide (TMAOH). In yet another aspect of this embodiment, delaminating the multi-layered MXene powder further includes filtering MXene from TMAOH to obtain the single-to-few-layered MXene flakes.

According to one embodiment, the present disclosure provides a method of producing a composition of matter defined by the general formula of M1M2M3M4X₃, the method includes: preparing precursor MAX phase powder; etching the MAX phase powder to obtain multi-layered MXene powder; and delaminating the multi-layered MXene powder to obtain single-to-few-layered MXene flakes having the general formula of M1M2M3M4X₃, wherein: X is carbon; and M1, M2, M3, and M4 each represent a different transition metal selected from the group consisting of Ti, Ta, Sc, Cr, Zr, Hf, Mo, V, and Nb. In one aspect of this embodiment, M1, M2, M3, M4 each represent a different transition metal selected from the group consisting of Ti, Ta, Cr, Mo, V, and Nb. In yet another aspect of this embodiment, the composition is selected from the group consisting of TiVNbMoC₃ and TiVCrMoC₃. In another aspect of this embodiment, the composition is a MXene. In yet another aspect of this embodiment, the composition is produced by at least: preparing precursor MAX phase powder; etching the MAX phase powder to obtain multi-layered MXene powder; and delaminating the multi-layered MXene powder to obtain single-to-few-layered MXene flakes. In another aspect of this embodiment, preparing precursor MAX phase powder includes mixing and reactive sintering elemental powders of equimolar ratio of four transition metals M1, M2, M3, and M4 with Al and C M1:M2:M3:M4:Al:C in 1:1:1:1:1.1:2.7 stoichiometric ratio to obtain one or more sintered MAX phase blocks. In yet another aspect of this embodiment, preparing precursor MAX phase powder further includes milling the one or more sintered MAX phase blocks to obtain the MAX phase powder. In a variant aspect of this embodiment, etching the MAX phase powder includes adding the MAX phase powder into an aqueous hydrofluoric acid to selectively etch away Al to obtain multi-layered MXene powder. In a variant aspect of this embodiment, delaminating the multi-layered MXene powder includes delaminating the multi-layered MXene powder using tetramethylammonium hydroxide (TMAOH). In yet another aspect of this embodiment, delaminating the multi-layered MXene powder further includes filtering MXene from TMAOH to obtain the single-to-few-layered MXene flakes.

According to one embodiment, the present disclosure provides a composition of matter defined by the general formula of M1M2M3M4AX₃, wherein: X is carbon; A is Al, and M1, M2, M3, and M4 each represent a different transition metal selected from the group consisting of Al, Ti, Ta, Sc, Cr, Zr, Hf, Mo, V, and Nb.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

The figures described herein are for illustration purposes only. The figures are not intended to limit the scope of the present disclosure.

FIG. 1A is a simplified schematic showing reactive sintering of high-entropy MAX phases, in accordance with embodiments of the disclosure.

FIG. 1B is a simplified schematic showing a high-entropy MAX unit cell, in accordance with embodiments of the disclosure.

FIG. 1C is a simplified schematic showing multi-layer high-entropy MXenes, in accordance with embodiments of the disclosure.

FIG. 1D is a simplified schematic showing single flakes of high-entropy MXenes, in accordance with embodiments of the disclosure.

FIG. 2A shows XRD patterns of high-entropy TiVNbMoAlC₃ MAX and TiVNbMoC₃ Tₓ MXenes, in accordance with embodiments of the disclosure.

FIG. 2B shows XRD patterns of high-entropy TiVCrMoAlC₃ MAX and TiVCrMoC₃ Tₓ MXenes, in accordance with embodiments of the disclosure

FIG. 3A is a SEM image of MAX powder of TiVNbMoAlC₃, in accordance with embodiments of the disclosure.

FIG. 3B is a SEM image of MAX powder of TiVCrMoAlC₃, in accordance with embodiments of the disclosure.

FIG. 3C is a SEM image of etched multi-layer MXene powder of TiVNbMoC₃ Tₓ, in accordance with embodiments of the disclosure.

FIG. 3D is a SEM image of etched multi-layer MXene powder of TiVCrMoC₃ Tₓ, in accordance with embodiments of the disclosure.

FIG. 3E is a SEM image of a single film of TiVNbMoC₃ Tₓ MXene flake, in accordance with embodiments of the disclosure.

FIG. 3F is a SEM image of a filtered film of TiVCrMoC₃ Tₓ MXene, in accordance with embodiments of the disclosure.

FIG. 4A-4F are XPS spectra of TiVNbMoC₃ Tₓ and TiVCrMoC₃ Tₓ, in accordance with embodiments of the disclosure.

FIG. 4G shows atomic % vs Ar+ etching time for TiVNbMoC₃ Tₓ, in accordance with embodiments of the disclosure.

FIG. 4H shows atomic % vs Ar+ etching time for TiVCrMoC₃ Tₓ, in accordance with embodiments of the disclosure.

FIG. 4I shows a High-angle annular dark-field (HAADF) STEM images of TiVNbMoC₃ Tₓ MXene, in accordance with embodiments of the disclosure.

FIG. 4J shows HAADF STEM images combined with EDS results of TiVNbMoC₃ Tₓ (top) and TiVCrMoC₃ Tₓ (bottom), in accordance with embodiments of the disclosure.

FIG. 5A shows differential scanning calorimetry results of Ti:V:Nb:Mo:1.1Al:2.7C powder mixture under argon flow, in accordance with embodiments of the disclosure.

FIG. 5B shows differential scanning calorimetry results of Ti:V:Cr:Mo:1.1Al:2.7C powder mixture under argon flow, in accordance with embodiments of the disclosure.

FIG. 6 shows four representative SEM images of TiVNbMoAlC₃ MAX particles that were used for EDS, in accordance with embodiments of the disclosure.

FIG. 7 shows four representative SEM images of TiVCrMoAlC₃ MAX particles that were used for EDS, in accordance with embodiments of the disclosure.

FIG. 8A shows XRD patterns of multiphases formed by sintering different ratios of Ti:V:Nb:Mo with Mo variation, in accordance with embodiments of the disclosure.

FIG. 8B shows XRD patterns of multiphases formed by sintering different ratios of Ti:V:Nb:Mo with Nb variation, in accordance with embodiments of the disclosure.

FIG. 8C shows XRD patterns of multiphases formed by sintering different ratios of Ti:V:Cr:Mo with Cr variation, in accordance with embodiments of the disclosure.

FIG. 9A shows a single-flake TiVCrMoC₃ Tₓ MXene solution after delamination with TMAOH, in accordance with embodiments of the disclosure.

FIGS. 9B-9C show few-layer TiVCrMoC₃ Tₓ MXene clay post delamination, in accordance with embodiments of the disclosure.

FIG. 9D shows TiVCrMoC₃ Tₓ MXene film doctor-bladed on a filter paper, in accordance with embodiments of the disclosure.

FIG. 9E shows a single-flake TiVCrMoC₃ Tₓ MXene solution after delamination with TMAOH, in accordance with embodiments of the disclosure.

FIGS. 9F-9G show few-layer TiVNbMoC₃ Tₓ MXene clay post delamination, in accordance with embodiments of the disclosure.

FIG. 9H shows TiVNbMoC₃ Tₓ MXene film doctor-bladed on a filter paper, in accordance with embodiments of the disclosure.

FIG. 10A is a SEM image showing a cross-sectional view of TiVNbMoC₃ Tₓ few-layered films, in accordance with embodiments of the disclosure.

FIG. 10B is a SEM image showing a cross-sectional view of TiVCrMoC₃ Tₓ few-layered films, in accordance with embodiments of the disclosure.

FIG. 10C is a SEM image showing a top view of TiVNbMoC₃ Tₓ few-layered films, in accordance with embodiments of the disclosure.

FIG. 10D is a SEM image showing a top view of TiVCrMoC₃ Tₓ few-layered films, in accordance with embodiments of the disclosure.

FIG. 11 shows XPS spectra of TiVNbMoC₃ Tₓ and TiVCrMoC₃ Tₓ, in accordance with embodiments of the disclosure.

FIG. 12 shows high-angle annular dark-field (HAADF) STEM images of delaminated TiVNbMoC₃ Tₓ (left) and TiVCrMoC₃ Tₓ (right) MXenes, HAADF STEM image of TiVCrMoC₃ Tₓ with EDS data indicating atomic distribution of Ti, V, Cr, Mo, C atoms, in accordance with embodiments of the disclosure.

FIG. 13 shows calculated electron concentration of synthesized MAX phases with reference to their relative formation energy, in accordance with embodiments of the disclosure.

FIG. 14 shows calculated configurational entropy in a two, three, and four-component solid solutions as a function of mol % of the Nth component.

### DETAILED DESCRIPTION

While the disclosed subject matter is amenable to various modifications and alternative forms, specific embodiments have been shown by way of example in the drawings and are described in detail below. The intention, however, is not to limit the subject matter disclosed herein to the particular embodiments described. On the contrary, the disclosure is intended to cover all modifications, equivalents, and alternatives falling within the scope of the subject matter disclosed herein, and as defined by the appended claims.

Aspects of the present disclosure relate to MXenes. MXenes may refer to 2D transition metal carbines and nitrides having n+1 (e.g., n=1 to 4) atomic layers of transition metals interleaved by carbon and/or nitrogen layers. MXenes may be described as having a chemical formula of Mn₊₁XₙTₓ (n=1 to 4), where a 2D MXene flake may be comprised of n+1 atomic layers of transition metals (M) from groups 3 to 6 of the periodic table interleaved by a layer of carbon and/or nitrogen (X) between the M layers. For example, transition metal may be Sc, Ti, V, Cr, Y, Zr, Nb, Mo, Hf, or Ta. In addition, the outer transition metal atomic layers may be bonded to surface terminations (T), such as —O, —F, and —OH. MXenes may exhibit superior metallic electrical conductivity, high in-plane mechanical stiffness, and impressive catalytic as well as electrochemically active behavior. MXenes may be synthesized from their precursors, the MAX phases, by selective etching of the A layers which may be from group 13-16 of the periodic table, such as Al.

Aspects of the present disclosure relate to synthesis of high-entropy MXenes and synthesis of MXene precursors of layered multi-principal element (MPE) MAX carbides. Specifically, aspects of the present disclosure relate to high-entropy (e.g., more than 3 principal elements) two-dimensional (2D) carbide MXenes, including carbide MXenes including four or more transition metals such as TiVNbMoC₃ and TiVCrMoC₃. Additionally, aspects of the present disclosure relate to precursor high-entropy MAX phases of the high-entropy two-dimensional (2D) carbide MXenes such as TiVNbMoAlC₃ and TiVCrMoAlC₃. Aspects of the present disclosure relate to pure single-phase high-entropy MXenes.

A method of synthesizing MPE MXene according to the present disclosure includes synthesizing single-phase purity layered MPE MAX carbides (e.g., TiVNbMoAlC₃ and TiVCrMoAlC₃), and exfoliating and delaminating the single-phase purity layered MPE MAX carbides to obtain MPE MXenes (e.g., TiVNbMoC₃ Tₓ and TiVCrMoC₃ Tₓ). In the synthesized high-entropy phases, the transition metal stoichiometric ratios may be retained at 1:1:1:1 (±0.2) for M1:M2:M3:M4.

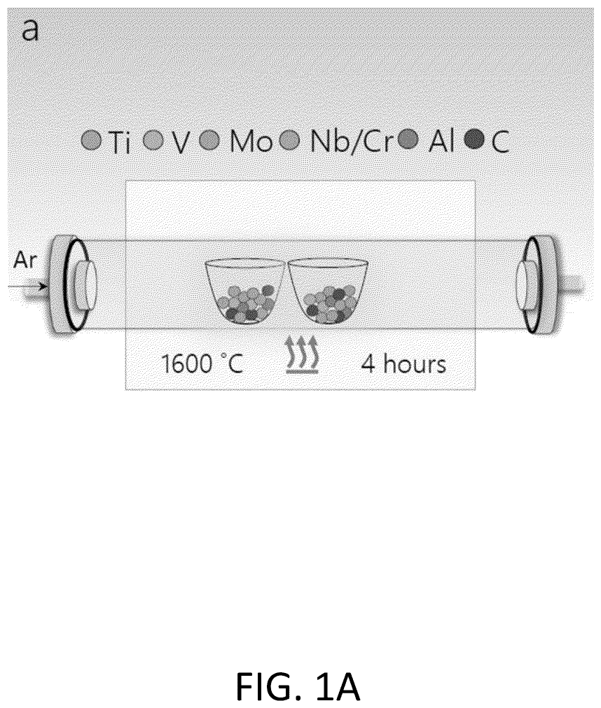

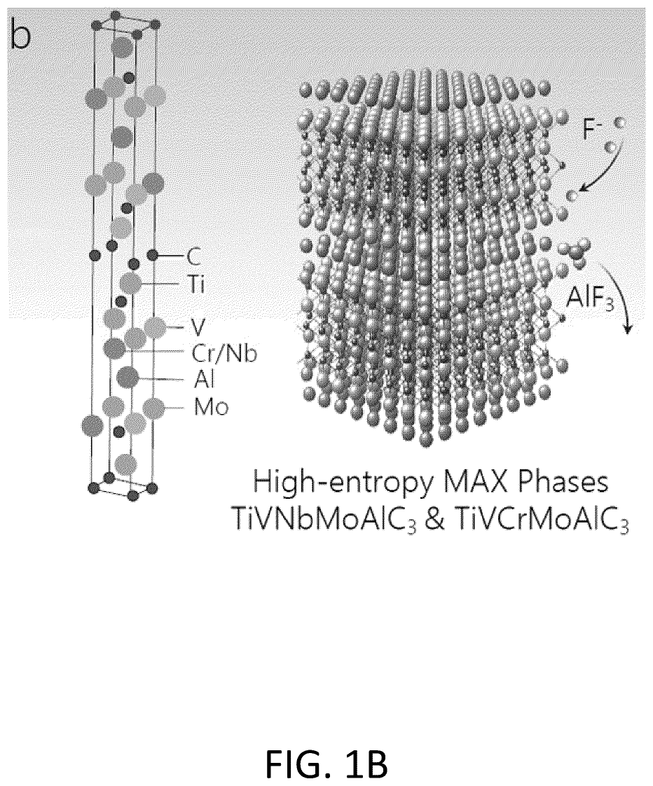

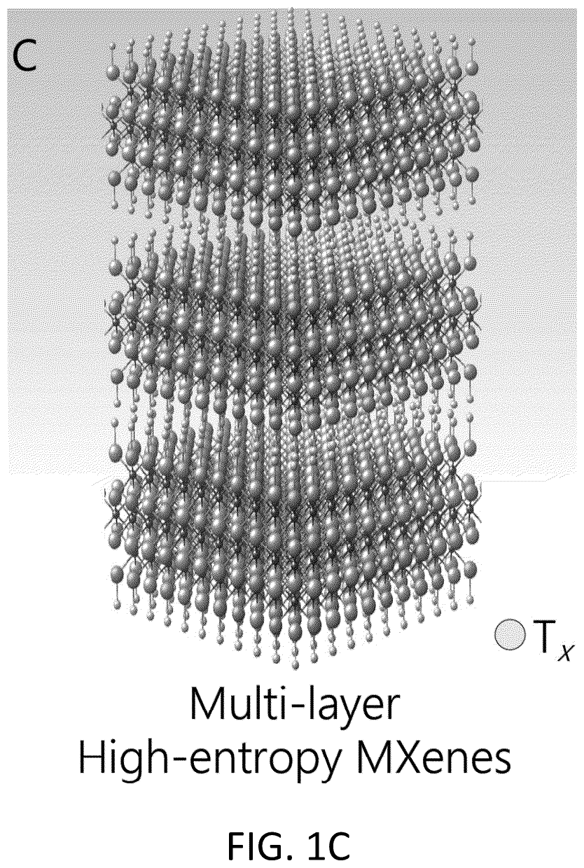

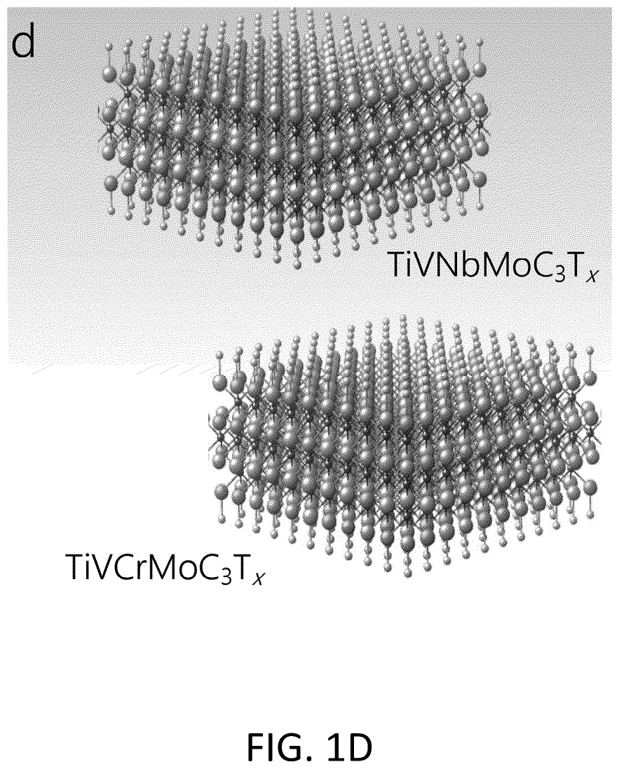

FIGS. 1A-1D depicts a method of synthesizing TiVNbMoC₃ Tₓ and TiVCrMoC₃ Tₓ MXenes according to the present disclosure. In various embodiments, high-entropy MAX phases TiVNbMoAlC₃ and TiVCrMoAlC₃ (FIG. 1B) may be synthesized by reactive sintering of elemental powders (FIG. 1A), which includes mixing an equimolar ratio of four transition metals M1, M2, M3, and M4 with Al and C M1:M2:M3:M4:Al:C in 1:1:1:1:1.1:2.7 stoichiometric ratio, reactive sintering the powders to obtain sintered blocks of the high-entropy MAX phases, and milling the sintered blocks of high-entropy MAX phases to obtain fine powders of the high-entropy MAX phases. As depicted, reactive sintering may be performed in a tube furnace with the powder mixtures placed in alumina crucibles and by heating the powder mixtures from room temperature to 1600° C. at 3° C./min in a tube furnace and holding time of 4 hours under argon atmosphere.

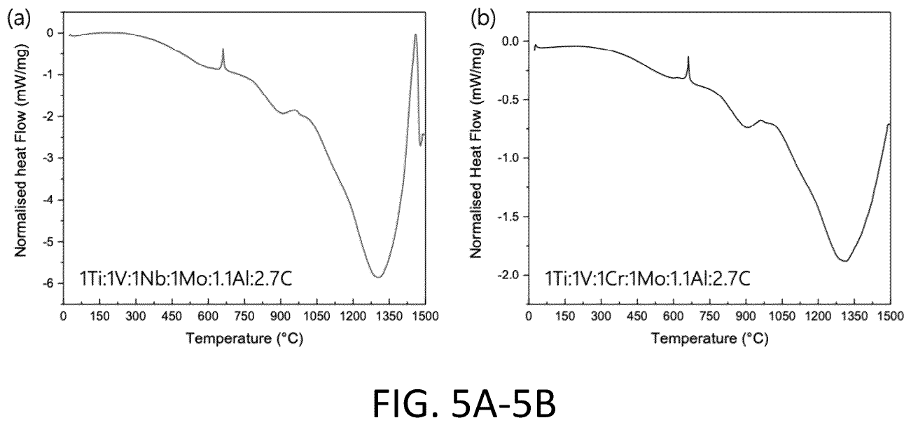

FIGS. 5A-5B show differential scanning calorimetry results of Ti:V:Nb:Mo:1.1Al:2.7C and Ti:V:Cr:Mo:1.1Al:2.7C powder mixtures under argon flow. Both powder mixtures have a peak between 653-664° C., which indicates the melting of Al and the start of reaction with the transition metals to form intermetallics. Binary can form with the initiation of carbon diffusion, followed by phase stabilization and ternary carbon formation between 1250-1350° C. At temperatures above 1450° C., high-entropy multi-principal element phases may form. The high-entropy MAX phases TiVNbMoAlC₃ and TiVCrMoAlC₃, as synthesized, include layered transition metal layers comprised of four transition metal elements (i.e., Ti, V, Nb or Cr, and Mo) with aluminum and carbon atomic layers in a M₄AlC₃ MAX structure.

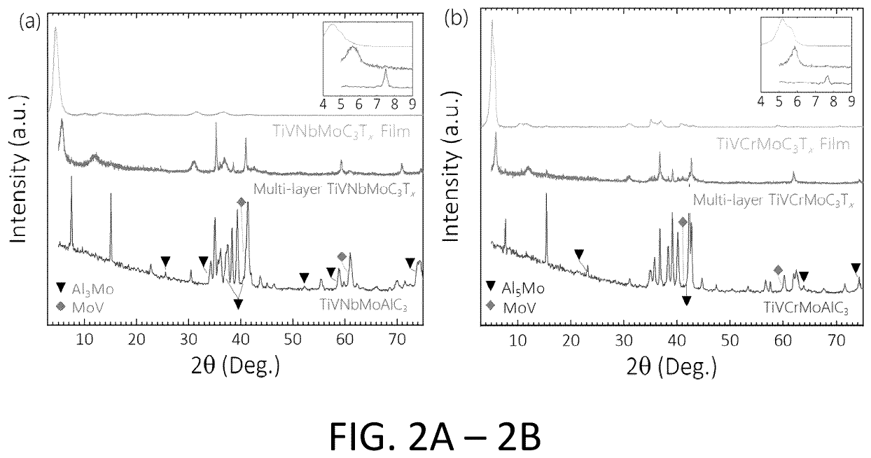

X-ray diffraction (XRD) may be used to analyze the sintered powders to verify the formation of high-entropy MAX phases. Specifically, the bottom patterns in FIGS. 2A-2B show the XRD spectra of sintered powders Ti:V:Nb:Mo:Al:C and Ti:V:Cr:Mo:Al:C, verifying the formation of TiVNbMoAlC₃ and TiVCrMoAlC₃ MAX phases. As shown, the spectra confirms the presence of M₄AlC₃ MAX phase peaks and their a-lattice parameters (a-LPs) were determined, based at least in part upon the characteristic (001) and in-plane peaks, to be 3.038 and 2.97 Å and c-LPs of 23.590 and 22.978 Å for TiVNbMoAlC₃ and TiVCrMoAlC₃, respectively. Additional characterization may be performed to identify the presence, if any, of impurity phases in the sintered powders. Common impurities may include very small amounts of Al—Mo and Mo—V intermetallics in both TiVNbMoAlC₃ and TiVCrMoAlC₃. As shown, the XRD spectra do show a very small number of intermetallic impurities but with no other clearly identifiable carbide or oxide impurities. The equimolar high-entropy stabilization synthesis method used by the present disclosure is thus verified as an effective method for forming highly pure M₄AlC₃ MAX phases, precursors to high-entropy MXenes.

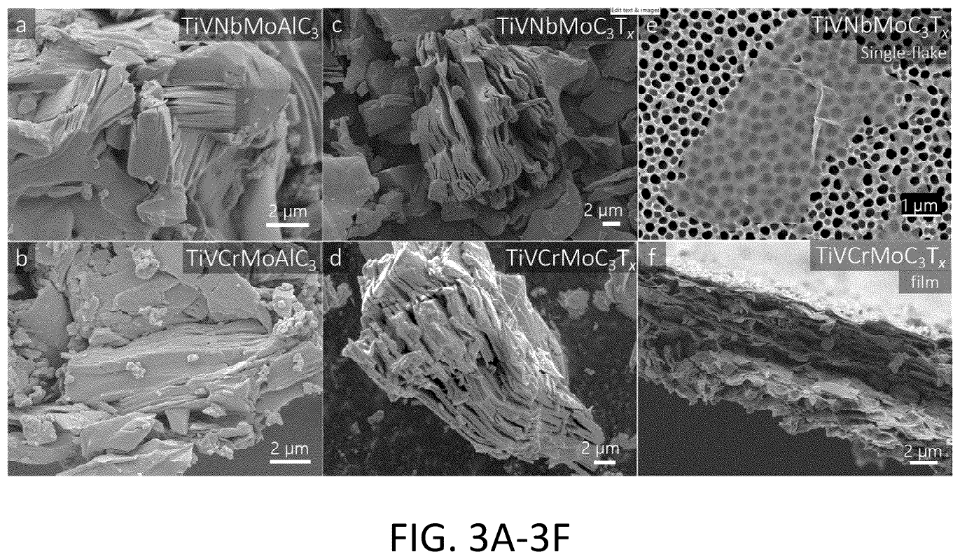

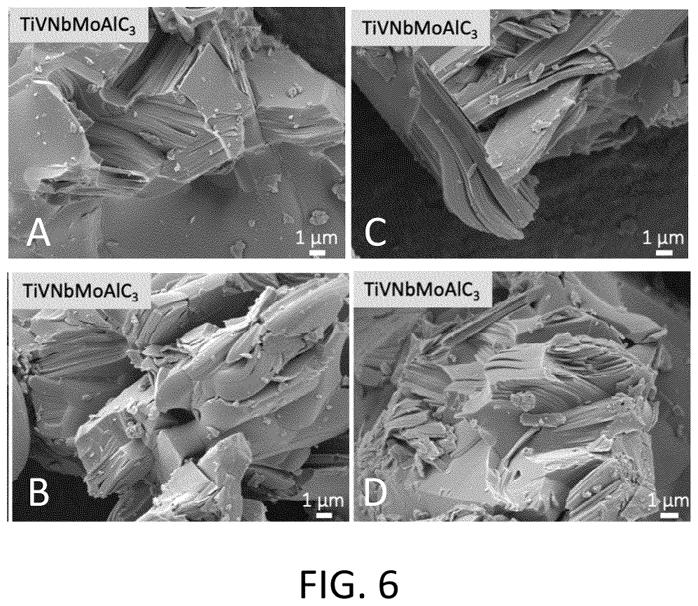

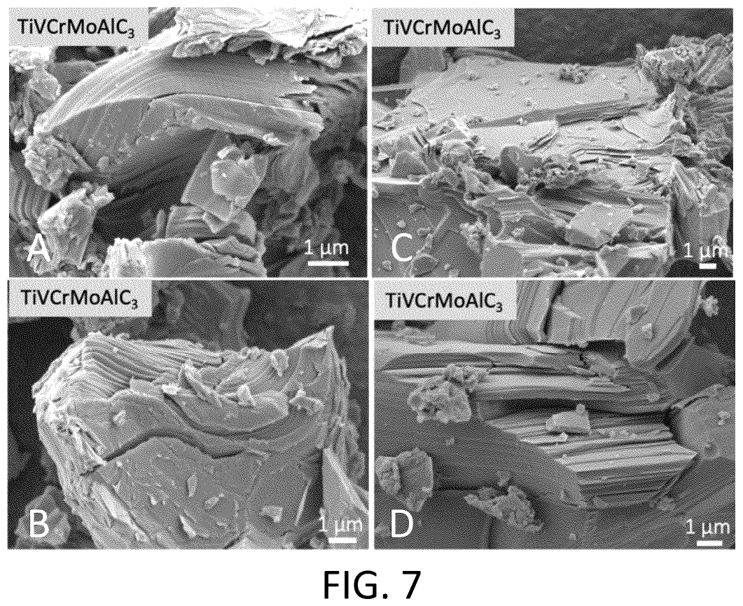

In addition to XRD analysis, energy-dispersive x-ray spectroscopy (EDS) combined with scanning electron microscopy (SEM) may be used to characterize the resultant composition of the formed MAX phases. To distinguish the compositions in the resulting MAX phases, EDS point scans on several MAX particles shown in SEM micrographs may be performed (FIGS. 3A-3B). As an example, the average EDS results for the four transition metals in each composition are shown in Table 1 for TiVNbMoAlC₃ and TiVCrMoAlC₃. Representative SEM images of the MAX particles that were used for EDS are shown for TiVNbMoAlC₃ and TiVCrMoAlC₃ in FIGS. 6-7. These results indicate an equimolar ratio of the four transition metals as Ti:V:Nb:Mo 0.9±0.2:1.1±0.2:1.1±0.2:0.9±0.3 and Ti:V:Cr:Mo ratio of 1.0±0.1:1.1±0.1:1.0±0.1:0.9±0.1. Al content was observed to be near stoichiometric ratio of 1.1±0.2 in both MAX phases. The EDS results confirm that the sintered powders are MPE MAX phases, specifically, TiVNbMoAlC₃ and TiVCrMoAlC₃.

TABLE 1

| EDS on particles | Ti | V | Cr | Nb | Mo | Al |
|---|---|---|---|---|---|---|
| (Ti,V,Nb,Mo)₄AlC₃ | 0.9 ± 0.2 | 1.1 ± 0.2 | — | 1.1 ± 0.2 | 0.9 ± 0.3 | 1.09 ± 0.2 |
| ML-(Ti,V,Nb,Mo)₄C₃Tₓ | 1.0 ± 0.1 | 1.0 ± 0.1 | — | 1.2 ± 0.4 | 0.8 ± 0.3 | — |
| d-(Ti,V,Nb,Mo)₄C₃Tₓ | 0.9 ± 0.2 | 1.0 ± 0.2 | — | 1.0 ± 0.2 | 0.9 ± 0.3 | — |
| (Ti,V,Cr,Mo)₄AlC₃ | 1.0 ± 0.1 | 1.1 ± 0.1 | 1.0 ± 0.1 | — | 0.9 ± 0.1 | 1.16 ± 0.15 |
| ML-(Ti,V,Cr,Mo)₄C₃Tₓ | 1.1 ± 0.2 | 1.2 ± 0.1 | 0.8 ± 0.3 | — | 0.9 ± 0.1 | |
| d-(Ti,V,Cr,Mo)₄C₃Tₓ | 1.1 ± 0.2 | 1.1 ± 0.2 | 0.9 ± 0.2 | — | 1.0 ± 0.2 | — |

At least supported by the XRD and EDS characterizations, the method for synthesizing MPE MAX phases according to the present disclosure is proven to achieve the effect of entropy stabilization to allow the use of four transition metals such as Ti—V—Nb—Mo or Ti—V—Cr—Mo combinations to synthesize stable, homogeneous, and single-phase M₄AC₃ MAX structures. The MPE MAX phases may be stabilized because of configurational entropy, which may be absent in non-high-entropy MAX structures.

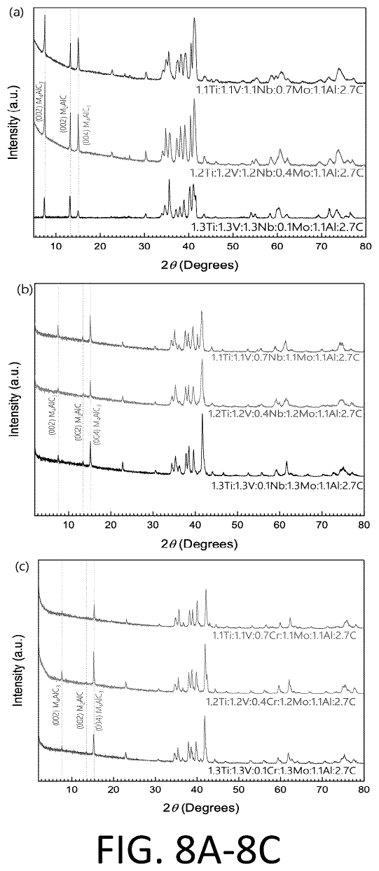

The effect of entropy stabilization in TiVNbMoAlC₃ and TiVCrMoAlC₃ may be verified by preparing non-equimolar mixtures of the transition metals with lowered Mo and Nb content in (Ti,V,Nb,Mo)₄AlC₃ and lowered Cr content in three mixtures in (Ti,V,Cr,Mo)₄AlC₃ from one to 0.7, 0.4, and 0.1. The mixtures with lowered Mo content may have ratios of Ti:V:Nb:Mo 1.1:1.1:1.1:0.7, 1.2:1.2:1.2:0.4, and 1.3:1.3:1.3:0.1 with Al:C 1.1:2.7. The non-equimolar mixtures may then be sintered at identical conditions to those for the equimolar ratio TiVNbMoAlC₃ MAX phase. As indicated by the XRD spectra (FIG. 8A), the resulting compositions were a mix of M₄AlC₃ and M₂AlC MAX phases for all three non-equimolar mixtures with lowered Mo content. The mixtures with lowered Nb content may have ratios of Ti:V:Nb:Mo 1.1:1.1:0.7:1.1, 1.2:1.2:0.4:1.2, and 1.3:1.3:0.1:1.3 with similar Al:C ratio of 1.1:2.7. As indicated by the XRD spectra (FIG. 8B), the resulting compositions were non-pure M₄AC₃ phases with M2AC impurities for all three non-equimolar mixtures with lowered Nb content. The mixtures with lowered Cr content may have ratios of Ti:V:Cr:Mo 1.1:1.1:0.7:1.1, 1.2:1.2:0.4:1.2, and 1.3:1.3:0.1:1.3 with Al:C 1.1:2.7. As indicated by the XRD spectra (FIG. 8C), the resulting compositions include impurity phases. Although all the nine powder mixtures were prepared and sintered at identical conditions to the equimolar ratio phases, XRD results indicated undesired M₂AlC MAX phases for all three non-equimolar mixtures with lowered Cr content. The undesired multiphases in the non-equimolar mixtures may include a mixture of solid solution phases. Simultaneous formation of two different MAX phases instead of a single-phase MPE in both TiVNbMoAlC₃ and TiVCrMoAlC₃ may suggest that entropy controls the transition from multiphase to a high-entropy single-phase, similar to other high-entropy alloys and ceramics.

Returning to the method of synthesizing TiVNbMoC₃ Tₓ and TiVCrMoC₃ Tₓ MXenes, etching of MAX phases may be performed using an aqueous hydrofluoric acid (HF) etching process. First, the sintered powders of TiVNbMoAlC₃ and TiVCrMoAlC₃ MAX phases may be added into 48% HF for four days at 55° C. to selectively etch Al atomic layers from the high-entropy MAX phases (FIG. 1C) followed by repeated washing to a neutral pH. The reaction pathways of high-entropy MAX phases in aqueous HF to high-entropy MXene formations are as follows:

### TiVNbMoAlC₃ to TiVNbMoC₃

$${TiVNbMoAlC}_{3} + 3 HF = {TiVNbMoC}_{3} + {AlF}_{3} + 3 / 2 {H}_{2} \\ {TiVNbMoC}_{3} + 2 {H}_{2} O = {{TiVNbMoC}_{3} ( OH )}_{2} + {H}_{2} \\ {TiVNbMoC}_{3} + 2 HF = {TiVNbMoC}_{3} {F}_{2} + {H}_{2}$$

### TiVCrMoAlC₃ to TiVCrMoC₃

$${TiVCrMoAlC}_{3} + 3 HF = {TiVCrMoC}_{3} + {AlF}_{3} + 3 / 2 {H}_{2} \\ {TiVCrMoAlC}_{3} + 2 {H}_{2} O = {{TiVCrMoC}_{3} ( OH )}_{2} + {H}_{2} \\ {TiVCrMoAlC}_{3} + 2 HF = {TiVCrMoC}_{3} {F}_{2} + {H}_{2}$$

XRD spectra of the etched and dried powders (FIGS. 2A-2B, middle patterns) show a shift of the (002) peak in both phases to 5.65° and 5.84° for multilayer TiVNbMoC₃ Tₓ and TiVCrMoC₃ Tₓ, respectively, which indicates an increase in the inter-flake spacing of 3.85 Å and 3.64 Å respectively, compared to their MAX phase precursors. The SEM images of the as-etched powders of TiVNbMoC₃ Tₓ and TiVCrMoC₃ Tₓ (FIGS. 3C-3D) show the accordion-like morphologies of multilayer powders, as expected after high-concentration HF etching. The inserts on FIGS. 2A-2B shows the shifting of the (002) peak during the evolution from MAX phase to multi-layer MXene and to single layer Maxene film.

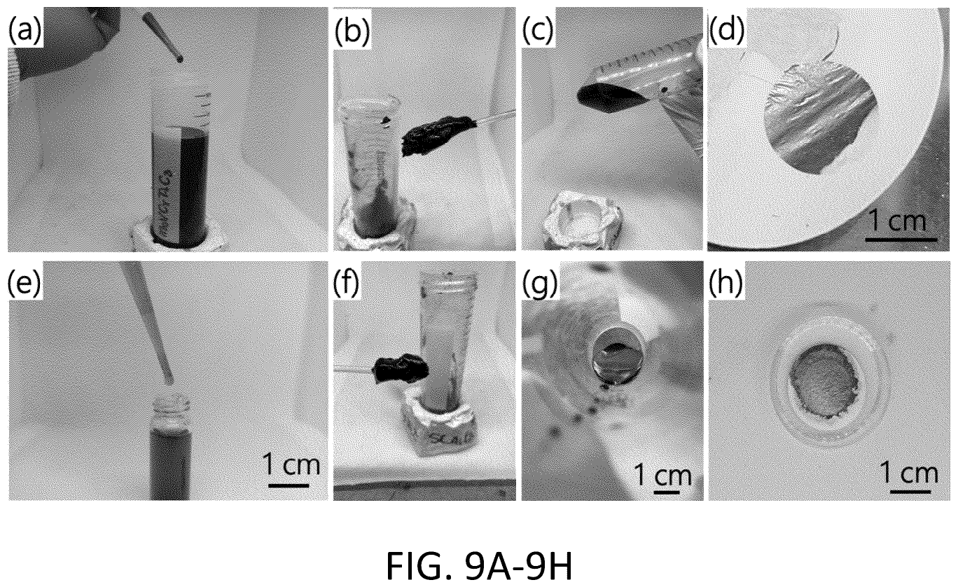

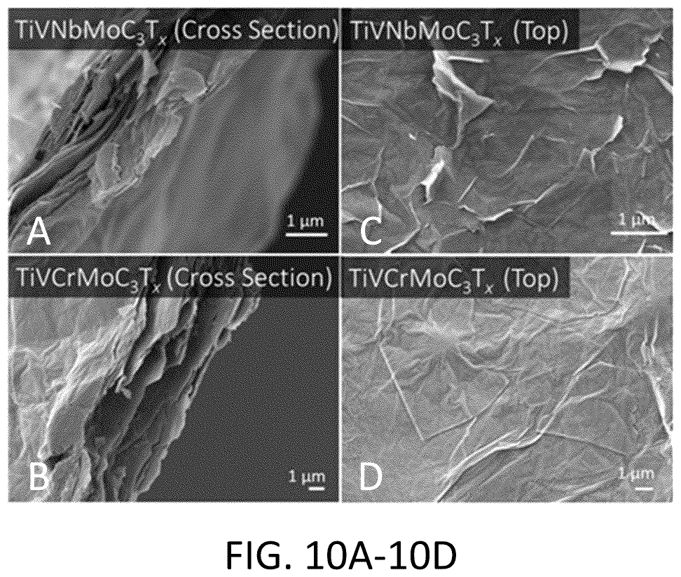

After etching, the method of synthesizing TiVNbMoC₃ Tₓ and TiVCrMoC₃ Tₓ MXenes further includes delaminating the exfoliated high-entropy MXenes into single flakes of 2D MXenes, such as using tetramethylammonium hydroxide (TMAOH) (FIG. 1D). FIG. 9A shows black colloidal solutions resulted from delamination of TiVNbMoC₃ Tₓ and TiVCrMoC₃ Tₓ multilayer powders with TMAOH. These solutions contain single-flake high-entropy MXenes (FIG. 3E, shown in an alumina substrate). The black colloidal solutions may next be filtered via vacuum-assisted filtration to obtain high-entropy MXene films (FIG. 3F, FIGS. 10A-10D). XRD spectra of the filtered films of TiVNbMoC₃ Tₓ and TiVCrMoC₃ Tₓ (FIGS. 2A-2B, top patterns) show only the basal plane peaks (00/peaks), which indicates MXene flake restacking during filtration. The most intense (002) peak positions are at 4.51° and 5.22° for TiVNbMoC₃ Tₓ and TiVCrMoC₃ Tₓ films, respectively, which show an increased inter-flake distance of 7.81 Å and 5.44 Å as compared to the original MAX c-LPs spacing. In addition, the (002) peak of TiVCrMoC₃ Tₓ illustrates “double” (002) peaks, where the most intense peak is at 5.22° with a less-intense shoulder peak at 5.65°. These double peaks indicate the partial drying of water molecules from the MXene film. TiVCrMoC₃ Tₓ has low-intensity peaks between 31° to 40° 2θ which do not correspond to (001) peaks. These peaks indicate non-basal plane reflections of MXene, which can be due to the remaining multilayer flakes of MXene particles as seen using cross-sectional SEM methods on the TiVCrMoC₃ Tₓ MXene film (FIG. 3F). The absence of non-basal plane reflections in the TiVNbMoC₃ Tₓ film and the relative low intensity of non-basal plane peaks in comparison to the highly intense (002) peaks in TiVCrMoC₃ Tₓ indicate that both films are either entirely or mostly, respectively, comprised of highly ordered single-to-few layers of high-entropy MXene flakes.

EDS and SEM may be performed to verify the composition of the etched multi-layer high-entropy MXene powders (FIGS. 3C-3D). The EDS point scans on the multilayer particles of TiVNbMoC₃ Tₓ and TiVCrMoC₃ Tₓ are presented in Table 1, which indicate that the MXene multilayer sheets retain their transition metals stoichiometric ratios of the MAX phase precursors (FIGS. 3A-3B) after HF etching. EDS results also show that Mo and Cr molar ratios in the measured multilayer particles are slightly lower than those in their respective MAX precursors (Table 1). The slightly lower concentration of Cr in the multi-layer high-entropy MXenes may be attributed to relatively weaker Cr—C bonds compare to other M-C bonds and the more reactive nature of Cr-containing MXenes during selective etching. In addition to entropy stabilization, the tendency of Mo and Cr to prefer the outer transition metal atomic layers in a MXene 2D flake may lead to Mo and Cr being exposed directly to HF during etching, which leads to their relatively higher removal rates while creating their transition metal vacancies in the outer M layers.

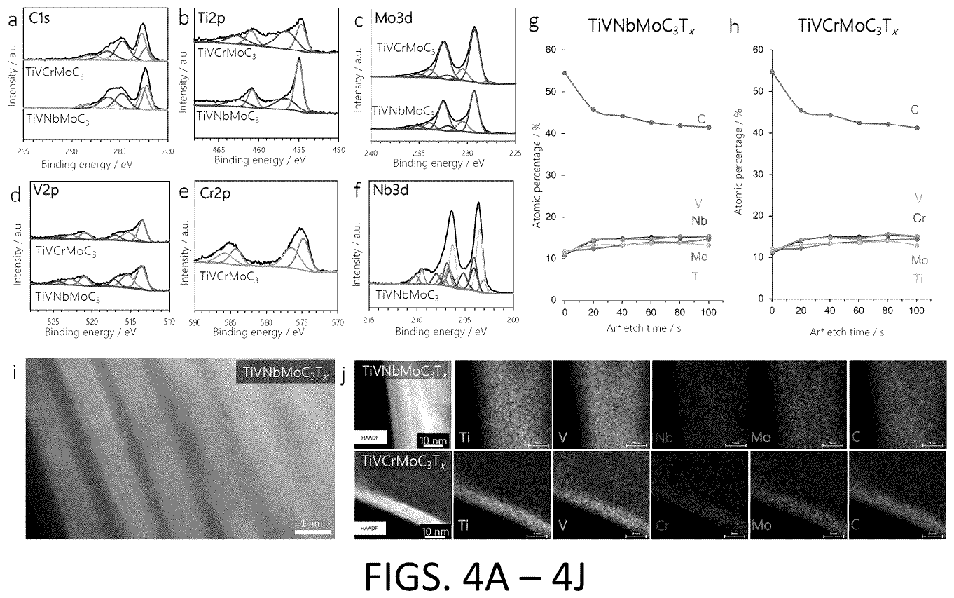

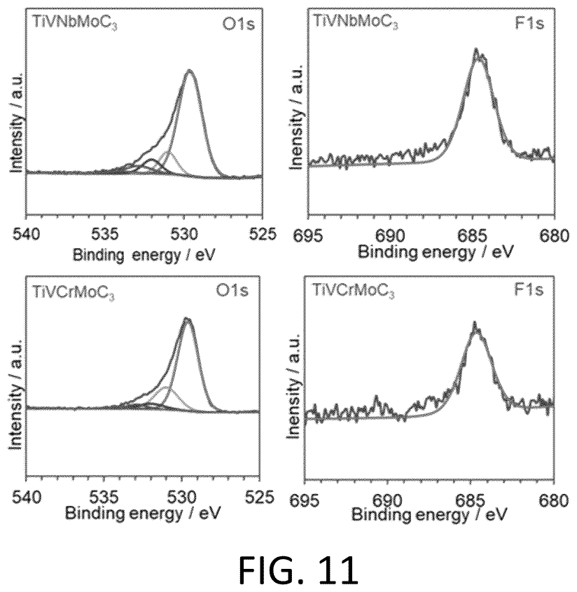

The compositions and chemical bonding within the high-entropy MXenes may be analyzed by conducting X-ray photoelectron spectroscopy (XPS) analysis to evaluate the chemical states as well as the coordination of the transition metals and carbon within the high-entropy TiVNbMoC₃ Tₓ and TiVCrMoC₃ Tₓ MXenes. Specifically, an average distribution of Ti, V, Nb/Cr, Mo, and C may be analyzed by setting the spot size to 400 μm for the XPS analyses. FIGS. 4A-4F show the XPS high-resolution spectra for the top surface of as-prepared TiVNbMoC₃ Tₓ and TiVCrMoC₃ Tₓ MXenes. The C1s high-resolution spectra highlight the existence of C—Mo/Ti— Tₓ, C—Ti/Mo Tₓ, C—C—CHₓ, C—O, and COO moieties in both structures. The Ti2p regions for both TiVNbMoC₃ Tₓ and TiVCrMoC₃ Tₓ highlights the coordination of Ti as Ti—C and TiO₂ (note that TiO₂ forms due to surface oxidation of the MXene). The V2p region suggests that V is coordinated via V²⁺/V⁴⁺ moieties or as V₂O₃, while the Mo3d region indicates that Mo exists as Mo⁵⁺/Mo⁶⁺, C—Mo— Tₓ, and Mo in both structures. For TiVNbMoC₃ Tₓ, the Nb coordination is composed of several species, including Nb⁰, Nb (I, II, or IV) NbO, Nb³⁺—O, Nb⁴⁺—O, and Nb₂O₅, and while in TiVCrMoC₃ Tₓ, the Cr coordinates as Cr²⁺ and Cr⁰.—O and —F groups are also observed, which indicate presence of surface moieties on the basal planes of the MXenes (FIG. 11), Table 2 and Table 3 include XPS deconvolution data for TiVNbMoC₃ Tₓ and TiVCrMoC₃ Tₓ, respectively.

TABLE 2
TiVNbMoC₃Tₓ

| Region | BE (eV) | | FWHM (eV) | Assigned to |
|---|---|---|---|---|
| Ti 2p | 454.8 | 461 | 1.3 | Ti—C |
| | 456.6 | 462.8 | 3.0 | TiO₂ |
| C 1s | 282.2 | | 1.0 | C—Mo/Ti—Tₓ |
| | 282.6 | | 1.0 | C—Ti/Mo—Tₓ |
| | 284.8 | | 1.7 | C—C |
| | 285.4 | | 1.5 | CHₓ |
| | 286.2 | | 2.0 | C—O |
| | 287.5 | | 2.0 | COO |
| O 1s | 530 | | 1.5 | MoOₓ/TiO₂/C—Mo—O(I) |
| | 530.9 | | 1.1 | C—Mo—O(II)x and/or OR |
| | 531.9 | | 1.2 | C—Mo—(OH)ₓ and/or OR |
| | 533 | | 1.4 | H₂Oads (IV) and/or OR |
| Mo 3d | 228 | 231.1 | 1.1 | Mo metal |
| | 229.3 | 232.5 | 1.1 | C—Mo—Tₓ |
| | 230.5 | 233.9 | 1.3 | Mo⁺⁵ |
| | 232 | 235.1 | 1.4 | Mo⁺⁶ |
| Nb 3d | 203.1 | 205.9 | 0.7 | Nb |
| | 203.5 | 206.3 | 0.8 | Nb |
| | 203.8 | 206.6 | 0.9 | Nb (I, II, or IV) |
| | 204.1 | 206.9 | 0.8 | NbO |
| | 205.2 | 208.0 | 0.9 | Nb(³⁺)—O |
| | 206.7 | 209.5 | 0.6 | Nb(⁴⁺)—O |
| | 207.4 | 210.2 | 0.8 | Nb₂O₅ |
| V 2p | 513.6 | 521 | 1.5 | V²⁺ |
| | 516.4 | 523.8 | 2.0 | V⁴⁺ |
| | 517.1 | 524.5 | 1.5 | V₂O₃ |

| | | | |
|---|---|---|---|
| O1s | 529.6 | 1.8 | TiO₂, MOₓ |
| | 531.0 | 1.4 | C—M—Oₓ (I) |
| | 532.0 | 1.5 | C—M—OHₓ (II) |
| | 532.9 | 2.0 | Al₂O₃ |
| | 534.0 | 2.0 | H₂O_{ads} (IV) |
| F1s | 684.6 | 2.3 | M—F |

TABLE 3
TiVCrMoC₃Tₓ

| Region | BE (eV) | | FWHM (eV) | Assigned to |
|---|---|---|---|---|
| Ti 2p | 454.8 | 461 | 1.5 | Ti—C |
| | 456.6 | 462.8 | 3.0 | TiO₂ |
| C 1s | 282.3 | | 1.0 | C—Mo/Ti—Tₓ |
| | 282.7 | | 1.1 | C—Ti/Mo—Tₓ |
| | 284.8 | | 1.7 | C—C |
| | 285.5 | | 1.5 | CHₓ |
| | 286.3 | | 2.0 | C—O |
| | 287.6 | | 2.0 | COO |
| O 1s | 530 | | 1.6 | MoOₓ/TiO₂/C—Mo—O(I) |
| | 530.9 | | 1.2 | C—Mo—O(II)ₓ and/or OR |
| | 531.9 | | 1.2 | C—Mo—(OH)ₓ and/or OR |
| | 533 | | 1.4 | H₂O_{ads} (IV) and/or OR |
| Mo3d | 228 | 231.1 | 1.1 | Mo metal |
| | 229.3 | 232.5 | 1.2 | C—Mo—Tₓ |
| | 230.5 | 233.9 | 1.3 | Mo⁺⁵ |
| | 232 | 235.1 | 1.4 | Mo⁺⁶ |
| Cr2p | 574.8 | 584.1 | 2.0 | Cr—C |
| | 576.4 | 585.7 | 2.8 | Cr—Tₓ |
| V 2p | 513.6 | 521 | 1.5 | V²⁺ |
| | 515.4 | 522.8 | 2.0 | v⁴⁺ |
| | 517.1 | 524.5 | 1.5 | V₂O₃ |

| | | | |
|---|---|---|---|
| O1s | 529.6 | 1.6 | TiO₂, MOₓ |
| | 531.0 | 1.9 | C—M—Oₓ (I) |
| | 532.0 | 2.0 | C—M—OHₓ (II) |
| | 532.9 | 1.5 | Al₂O₃ |
| | 534.0 | 2.0 | H₂O_{ads} (IV) |
| F1s | 684.6 | 2.2 | M—F |

XPS depth profiles with Art etching may be performed to analyze the distribution and evaluate the presence of Ti, V, Nb/Cr, Mo, and C in TiVNbMoC₃ Tₓ and TiVCrMoC₃ Tₓ (FIGS. 4G, 4H). Art etching XPS helps provide reliable data on the composition of the constituent elements to overcome possible surface oxidation caused by air exposure. The etching with Art ions at a rate of 0.05 nm/s enabled removal of surface impurities and the relative magnitude of the elemental deviation was more apparent after 20-30 s of Art etching (FIGS. 4G-4H), which is in agreement with the EDS results on the multi-layer MXenes (Table 1). The XPS depth profiling indicates that the distribution of Ti, V, Nb/Cr, Mo, and C was relatively constant through the MXene films, suggesting that the MXenes have a relatively uniform distribution of the transition metals in the structure. With increasing depth, the concentration of each transition metal element approaches the equimolar concentration of the high-entropy MXenes as observed in their precursor MAX phases. This also indicates that the topochemical etching process in aqueous HF and the delamination process did not alter the transition metal ratios.

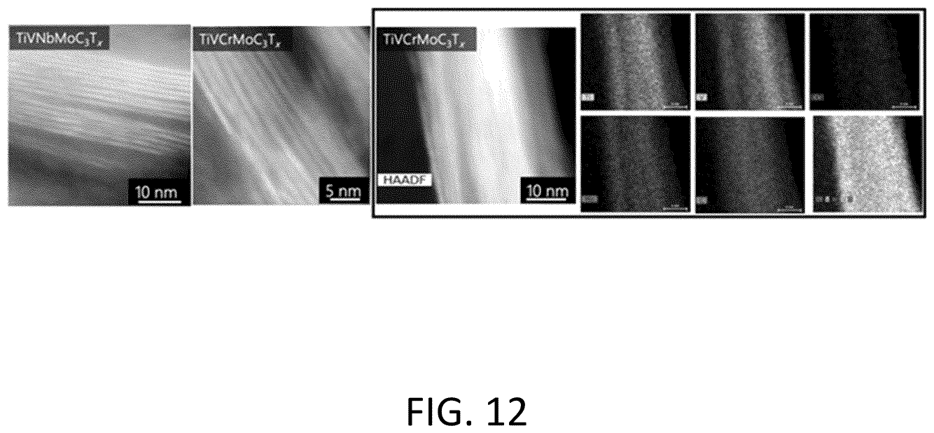

The composition of the synthesized high-entropy MXenes may be further characterized using scanning transmission electron microscopy (STEM) analysis combined with EDS. Specifically, elemental distribution and nanostructure of TiVNbMoC₃ Tₓ and TiVCrMoC₃ Tₓ flakes may indicate a 4-atomic-layer structure with elements mapped. For example, to probe the structure of MXenes, samples may be drop-cast from delaminated MXene solutions on a lacey carbon-coated Cu grid. FIG. 4I shows high-angle annular dark-field (HAADF) STEM image of TiVNbMoC₃ Tₓ, indicating that each MXene flake is composed of four transition metal atomic layers. EDS mapping (FIG. 4J and FIG. 12) of each MXene compositions reveals that Ti, V, Nb/Cr, Mo, and C are distributed across the transition metal layers, signifying the near equimolar distribution of the transition metals in high-entropy MXenes.

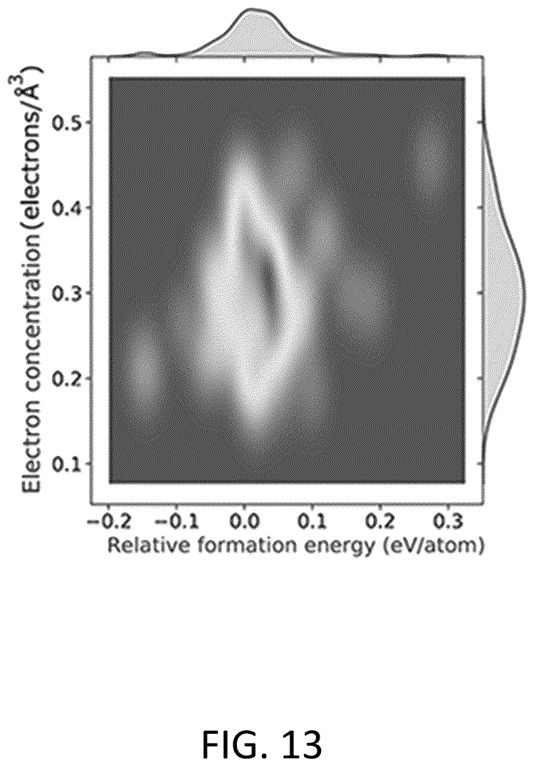

Computational studies based on first principles approaches were performed to help understand the synthesizability of high-entropy MAX and MXene phases as well as to quantify the thermodynamic stability of the MAX compositions. Specifically, the formation enthalpy (ΔH) of the MAX compositions with reference to the combination of most competitive phases, ΔH_{cp}=ΔH_{MAX phase}−ΔH_{competitive phases}, was studied. The formation enthalpy of different phases was calculated using the total energy of those phase structures and the total energies (per atom) of the M, A, and X elements in their standard state (bulk phases). The most competing phases were then identified using a linear optimization process. The negative ΔHop specifies the relative stability of MAX phases with respect to the competitive phases. In general, the more negative enthalpy values indicate higher possibility for their experimental realization. The compositions of the MAX phases along with their enthalpies of formation as well as lattice parameters are given in Table 4. The Bader charges of the transition metals for both high-entropy MAX phases are also presented in Table 5. The calculated electron concentration of the already synthesized MAX phases with reference to their relative formation energies is shown in FIG. 13.

TABLE 4

| | | | | Most competing | ΔH_{cp} | Electron Concentration |
|---|---|---|---|---|---|---|
| MAX Phases | a (Å) | b (Å) | c (Å) | phases | (eV/atom) | (electron/Å³) |
| (TiVCrMo)AlC₃ | 2.985 | 2.985 | 23.066 | Ti₃AlC₂, V₃AlC₂, | −0.011 | 0.405 |
| | | | | Cr₃C₂, Mo₃Al, C | | |
| (TiVNbMo)AlC₃ | 3.055 | 3.054 | 23.601 | Ti₃AlC₂, V₃AlC₂, | 0.033 | 0.367 |
| | | | | Nb₃AlC₂, MoC | | |
| (Ti_{1.33}Vi_{1.33}Nb_{1.33})AlC₃ | 3.044 | 3.050 | 23.557 | Ti₃AlC₂, V₃AlC₂, | 0.014 | 0.356 |
| | | | | Nb₃AlC₂, C | | |

TABLE 5

| Composition | Ti | V | Cr/Nb | Mo |
|---|---|---|---|---|
| TiVCrMoAlC₃ | 1.307 | 1.121 | 0.893 | 0.759 |
| TiVNbMoAlC₃ | 1.314 | 1.126 | 1.308 | 0.778 |

Probable reaction paths for formation of high-entropy MAX phases in Table 4 include:

$$( TiVCrMo ) {AlC}_{3} ⇌ 1 / 3 {Ti}_{3} {AlC}_{2} + 1 / 3 {V}_{3} {AlC}_{2} + 1 / 3 {Cr}_{3} {C}_{2} + 1 / 3 {Mo}_{3} Al + C \\ ( TiVNbMo ) {AlC}_{3} ⇌ 1 / 3 {Ti}_{3} {AlC}_{2} + 1 / 3 {V}_{3} {AlC}_{2} + 1 / 3 {Nb}_{3} {AlC}_{2} + MoC \\ ( {Ti}_{1.33} {V}_{1.33} {Nb}_{1.33} ) {AlC}_{3} ⇌ 1 / 3 {Ti}_{3} {AlC}_{2} + 1 / 3 {V}_{3} {AlC}_{2} + 1 / 3 {Nb}_{3} {AlC}_{2} + C$$

Table 5 results show that Ti elements gain more charge in TiVNbMoAlC₃ than TiVCrMoAlC₃, while the charge of V and Mo elements are identical in both compositions. Additionally, more charges are transferred to the Nb element in TiVNbMoAlC₃ composition in comparison to the Cr element in TiVNbMoAlC₃ because the Nb and Cr elements need three and two electrons to fill their valence shell, respectively.

Referring to FIG. 13, no specific value for ΔH_{cp} can be directly applied as a constraint for the thermodynamic stabilities of the MAX candidates. This is because the formation of many metastable materials is possible by controlling the temperature, pressure, and synthesis method. However, a lower value of ΔH indicates a higher probability of the MAX phase formation. The calculated ΔH_{cp} values (eV/atom) at 0 Kelvin for the MAX phases confirm that MAX phases of Sc₂AlC, Ti₂AlC, Ti₃AlC₂, and Ti₄AlC₃ with the ΔHop values of 0.10, 0.039, 0.039 and 0.038 eV/atom respectively, have already been synthesized. Both an inadequate number of valence electrons occupying bonding states and an abundance of valence electrons occupying antibonding states reduce the probability of the successful synthesis of the MAX candidates.

Electron concentration for the MAX phases that have already been synthesized with reference to their relative formation energies may be calculated (FIG. 13). As shown, the synthesizability of MAX candidates is higher in those candidates with an electron concentration close to 0.3 (electrons/atom); however, no MAX phases have been formed with the electron concentration below 0.2 and above 0.43 (electrons/atom).

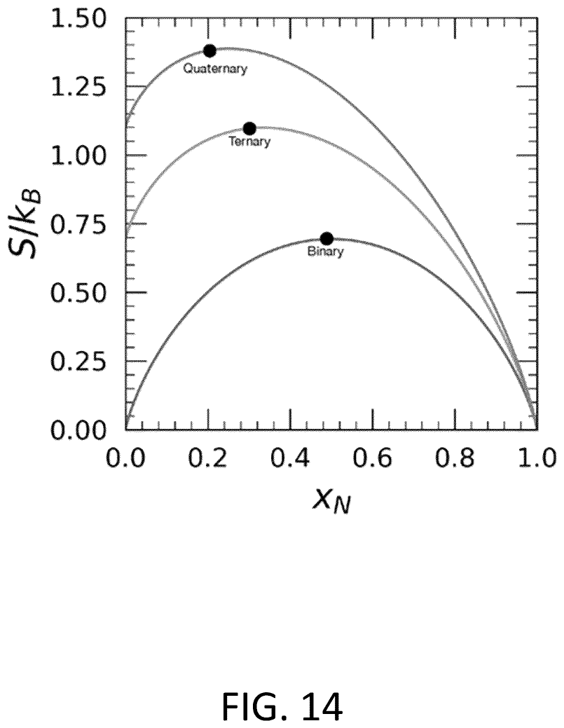

In multicomponent systems, a major contributor to their stabilization arises from configurational entropy i.e. statistically the number of discrete representative positions of the alloy constituents which is dependent on the number of elements in the system under consideration. The entropic contribution for the ternary and quaternary MAX systems can be calculated using:

$$Δ {S}_{mix} = - R {\sum }_{i = 1}^{k} {x}_{i} ln {x}_{i}$$

where xi is the mole fraction of the Ah component in a system with k total components. The calculated entropic contribution at 1600° C. for ternary and quaternary systems are −0.1773 eV/f.u. and −0.2238 eV/f.u. respectively. Based on configurational entropy, the four-element MAX phase has more favorable entropy to form as a single-phase compared to the three-element one (FIG. 14). The entropic stabilization explains the preference for four-element single-phase MAX phase as compared to three-element phases of MAX under similar synthesis conditions. Note, however, that our enthalpy calculations reveal that the three-element MAX is also synthesizable (Table 4). Since only one synthesis temperature and duration (1600° C.-4 h) were used for the consistency, the single-phase formation of the three-element MAX by further annealing at a desired temperature and duration remains a possibility. A lower contribution of configurational entropy can lead to the formation of a multiphase system (e.g., undesired phases) in the absence of post-annealing treatment.

In certain embodiments, various high-entropy MXenes in addition to TiVNbMoC₃ and TiVCrMoC₃ may be prepared following the methods of the present disclosure. For example, TiCrMoTaAlC₃ and TiCrNbTaAlC₃ high-entropy MAX phases may be prepared via reactive sintering, and through etching and delamination, TiCrMoTaC₃ and TiCrNbTaC₃ high-entropy MXene flakes may be obtained. Specifically, high-entropy MAX phases TiCrMoTaAlC₃ and TiCrNbTaAlC₃ may be synthesized by mixing an equimolar ratio of four transition metals Ti, Cr, Mo or Nb, and Ta with Al and C Ti:Cr:Mo or Nb:Ta:Al:C in 1:1:1:1:1.1:2.7 stoichiometric ratio, reactive sintering the powders to obtain sintered blocks of the high-entropy MAX phases, and milling (e.g., for 12 h) the sintered blocks of high-entropy MAX phases to obtain fine powders of the high-entropy MAX phases. Reactive sintering may be performed in a tube furnace with the powder mixtures placed in alumina crucibles and by heating the powder mixtures from room temperature to 1600° C. at 3.5° C./min in a tube furnace and holding time of 4 hours under argon atmosphere. Further, high-entropy MAX phases TiCrMoTaAlC₃ and TiCrNbTaAlC₃ may be etched using an aqueous hydrofluoric acid (HF) etching process, such as by adding the MAX phases into 48% HF for four days at 55° C. to selectively etch Al atomic layers from the high-entropy MAX phases followed by repeated washing to a neutral pH. Further, multilayered MXenes obtained from etching may further be delaminated using tetramethylammonium hydroxide (TMAOH) into single-to-few-layered MXene flakes, which may be obtained through filtration.

Aspects of the present disclosure relate to synthesis of high-entropy TiVNbMoAlC₃ and TiVCrMoAlC₃ MAX phases and further processing them into high-entropy TiVNbMoC₃ Tₓ and TiVCrMoC₃ Tₓ MXenes with an equimolar proportion of Ti:V:Nb:Mo and Ti:V:Cr:Mo principal transition metals. Specifically, the high-entropy MAX phases formed using pressure-less reactive sintering may be transformed into single-to-few layer MXenes by utilizing hydrofluoric acid-based selective etching followed by tetramethylammonium hydroxide delamination. As supported by XRD, SEM and STEM analysis, methods of producing high purity high-entropy MAX phases and subsequent single-to-few layer high-entropy MXenes according to embodiments of the present disclosure have been proven to be effective. Additionally, the bonding characteristics in high-entropy MXenes using XPS and the equimolar composition of transition metals have been identified utilizing EDS in SEM. EDS elemental mapping in STEM further shows the equimolar distribution of transition metals in the transition metal layers in the delaminated single-to-few-layer MXenes. The first-principles calculations trace the synthesizability of quaternary high-entropy MAX to an entropy driven stabilization and highlight the importance of high configurational entropy in equimolar multi-elements in forming pure and stable phases of MPE MAX phases. The present disclosure discloses effective methods of synthesizing high-entropy MAX and MXene materials by maximizing the configurational entropy to stabilize equimolar, or near equimolar, mixtures in a fashion analogous to that in other disordered multicomponent systems (e.g., bulk ceramics and metals). Successful synthesis of this new subgroup of high-entropy MPE MXenes adds a large possible compositional space to the growing family of MXenes, which can be explored for applications ranging from energy storage, catalysis, and microstructural stability in extreme environment.

### Synthesis of High-Entropy MAX Phases

All elements Ti (325 mesh), V (325 mesh), Mo (250 mesh), Nb (325 mesh), Cr (325 mesh), Al (325 mesh), C (calcinated coke) (325 mesh), and reagents HF (48 wt % aqueous), Tetramethylammonium hydroxide (TMAOH) (25% w/w aqueous) were obtained from Fisher Scientific and used without further processing unless specified. For Al and C, additional amount (˜0.1 moles) of Al were added to compensate for any evaporation during the MAX synthesis. In general, the Al to transition metal ratio in MAX phases of similar structures (M₄AC₃ here) is similar regardless of the transition metal type. Less than stoichiometric ratio of C were used. Molar ratios of the elemental powders for Ti/V/Nb/Mo/Al/C and Ti/V/Cr/Mo/Al/C were 1:1:1:1:1.1:2.7 respectively, and the blends were milled in polycarbonate jars on a tumbler mill with zirconia balls at a powder to ball weight ratios of 1:5 for 18 h at 60 rpm. Ball milled powders were transferred to alumina crucibles and sintered in a conventional tube furnace (Carbolite Gero) fitted with an alumina tube at 1600° C., held for 4 h. The temperature ramp rate was 3.5° C./min. The furnace was flushed with Ar gas for 10-15 min prior to firing of the MAX powders. A constant Ar flow was maintained throughout the run till the samples reached room temperature. Post cooling, the synthesized MAX phases were drilled with a TiN-coated drill bit and sieved with a 40 μm sieve to obtained uniform grains of MAX powder for etching.

### Synthesis and Delamination of High-Entropy MXenes

MXenes (both TiVNbMoC₃ and TiVCrMoC₃) were synthesized via top-down synthesis, by selective etching of their respective MAX phases. In a typical experiment, 2 g of MAX was added slowly (˜60 s) to a polycarbonate jar filled with 20 ml of HF (48 wt %) and held at 55° C. with continuous stirring at 400 RPM for 4 days. The etched MXene was washed repeatedly 4-5 times (˜250 ml with DI water) in a centrifuge at 4200 RPM with each typical run lasting 3-5 min. The pH (>6) neutralized etched MXene cakes were obtained via vacuum-assisted filtration with a 2.5 micron cellulose filter paper. The etching process is identical for both TiVNbMoAlC₃ and TiVCrMoAlC₃ phases. Filtered MXene cakes were subsequently delaminated with 5 wt % TMAOH with continuous stirring at 500-600 RPM for 4 h at 55° C. The delaminated MXenes were washed repeatedly for 5 times (˜250 ml with DI water) in a centrifuge at 10000 RPM with variable times (5-10 min) to bring the pH to ˜6. The supernatant was collected and films were made by vacuum-assisted filtration. FIG. 9 shows the supernatant, clay, and films of TiVCrMoC₃ and TiVNbMoC₃ MXenes.

### Microstructural Characterization-XRD

The structural characteristics of the MAX phases and MXenes were characterized using a Bruker D8 Discover x-ray diffractometer with a Cu K (alpha) radiation wavelength of 1.54184 Å paired with the Vantec two-dimensional detector (XRD²). The scans were carried out from 5-75 deg 2θ (0-90°) using step sizes of 5° 2θ with a time step of 60 s/step. MAX phase and multi-layer MXene powders were placed into cylindrical holes on an aluminum substrate with dimensions 5 mm diameter×1.5 mm depth. The MAX powders were preferentially ordered using a clean glass slide for pressing on the top of the powder samples. TiVNbMoC₃ and TiVCrMoC₃ MXene single-to-few layer films were cut into 5 mm×10 mm rectangular pieces and one of these film pieces was stacked on an amorphous double-sided carbon tape on a clean glass substrate. The sample height was aligned using dual-focused laser beams. Spectral data was analyzed with crystal impact software, Match!

### Microstructural Characterization—SEM/EDS

A JEOL JSM-7800F FESEM equipped with an in-lens thermal field emission electron gun and a conical objective lens with in-tandem upper and lower electron detectors was used to collect morphological and compositional data of the samples. All specimens were sputter-coated with gold (Denton Desk V Turbo) to enhance conduction on the surface. Energy Dispersion Spectroscopy was performed via an EDAX Octane Super Detector and associated EDAX TEAM software. The working distance (10 mm) and elevation angle (35°) were fixed along with a scale setting of 58 for the EDS analyses. the dead time for each run was manually adjusted to 27-35. A random spot was selected and was analyzed point-wise (at 10 spots) with an excitation voltage of 15-25 kV and a peak current of 8-10 Amp. A Magnification of 1000 kX was used for obtaining the composition of the MXene films.

### Microstructural Characterization-XPS and STEM/EDS

X-ray photoelectron spectroscopy (XPS) spectra were collected for each MXene using the free-standing films, made by vacuum filtration of their delaminated solutions, on a Thermo K-alpha XPS system with a spot size of 400 μm at an energy resolution of 0.1 eV. Art sputtering was carried out with a beam energy of 4 eV and the cluster size was 1000 atoms. For the XPS depth profiles, the atomic percentages were calculated for only Ti, V, Mo, Cr/Nb, and C. All XPS spectra were analyzed using Thermo Avantage, a software package provided through ThermoScientific. Scanning transmission electron microscopy (STEM) was performed on an FEI Talos TEM/STEM equipped with an EDS detector (Bruker) operated at 200 kV. Elemental maps were collected with a STEM spot size of 6. All S/TEM specimen were prepared by dispersing freestanding MXene films, made from delaminated MXene solutions, in D.I. H₂O and drop-casting the dispersion onto lacey carbon-coated copper grids.

### Microstructural Characterization—First-Principles Calculations

To simulate the chemical disorder of actual high entropy MAX while maintaining a tractable size for the computational cell, special quasi-random structures (SQSs) as implemented in the ATAT software package were ysed. For the quaternary MAX phase, a 2×2×1 supercell was used whereas in case of ternary system, a supercell of 3×3×1 from the parent MAX phase was used. The Perdue-Burke-Ernzerhof (PBE) exchange-correlation functional and the projected augmented wave approach were used through its implementation in the Vienna Ab-Initio Simulation Package (VASP). The MAX phase structures were fully optimized through relaxation of the unit-cell shape, atomic positions, and volume using the conjugate gradient method until the maximum residual force acting on each atom became less than 0.01 eV/Å. The electronic energy convergence criterion used is 10⁻⁶ eV/cell having a plane wave cut-off energy of 520 eV. The Brillouin zone was integrated using Monkhorst-Pack k-point sampling method. A dense k-point grid was employed, defined by nₐₜₒₘₛ×nₖ₋ₚₒᵢₙₜₛ˜1000, where n atoms is the number of atoms in the primitive cell and nₖ₋ₚₒᵢₙₜₛ being the number of k-points respectively.

It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of

1. A composition of matter comprising a high-entropy two-dimensional carbide MXene having a general formula of M1M2M3M4X₃, wherein:
X is carbon; and
M1, M2, M3, and M4 each represent a different transition metal selected from the group consisting of Ti, Ta, Sc, Cr, Zr, Hf, Mo, V, and Nb.

2. The composition of claim 1, wherein M1, M2, M3, M4 each represent a different transition metal selected from the group consisting of Ti, Ta, Cr, Mo, V, and Nb.

3. The composition of claim 1, wherein the composition is selected from the group consisting of TiVNbMoC₃ and TiVCrMoC₃.

4. (canceled)

5. The composition of claim 1, wherein the composition is produced by at least:
Preparing high-entropy precursor MAX phase powder;
etching the high-entropy precursor MAX phase powder to obtain high-entropy multi-layered MXene powder; and
delaminating the high-entropy multi-layered MXene powder to obtain single-to-few-layered high-entropy two-dimensional carbide MXene flakes.

6. The composition of claim 5, wherein preparing the high-entropy precursor MAX phase powder includes mixing and reactive sintering elemental powders of equimolar ratio of four transition metals M1, M2, M3, and M4 with Al and C M1:M2:M3:M4:Al:C in 1:1:1:1:1.1:2.7 stoichiometric ratio to obtain one or more sintered MAX phase blocks.

7. The composition of claim 6, wherein preparing the high-entropy precursor MAX phase powder further includes milling the one or more sintered MAX phase blocks to obtain the high-entropy precursor MAX phase powder.

8. The composition of claim 5, wherein etching the high-entropy precursor MAX phase powder includes adding the high-entropy precursor MAX phase powder into an aqueous hydrofluoric acid to selectively etch away Al to obtain the high-entropy multi-layered MXene powder.

9. The composition of claim 5, wherein delaminating the high-entropy multi-layered MXene powder includes delaminating the high-entropy multi-layered MXene powder using tetramethylammonium hydroxide (TMAOH).

10. The composition of claim 9, wherein delaminating the high-entropy multi-layered MXene powder further includes filtering the high-entropy multi-layered MXene from TMAOH to obtain the single-to-few-layered high-entropy two-dimensional carbide MXene flakes.

11. A method of producing a composition of matter comprising a high-entropy two-dimensional carbide MXene having a general formula of M1M2M3M4X₃, the method comprising:
preparing high-entropy precursor MAX phase powder;
etching the high-entropy MAX phase powder to obtain high-entropy multi-layered MXene powder; and
delaminating the high-entropy multi-layered MXene powder to obtain single-to-few-layered high-entropy two-dimensional carbide MXene flakes having the general formula of M1M2M3M4X₃;
wherein:
X is carbon; and
M1, M2, M3, and M4 each represent a different transition metal selected from the group consisting of Ti, Ta, Sc, Cr, Zr, Hf, Mo, V, and Nb.

12. The method of claim 11, wherein M1, M2, M3, M4 each represent a different transition metal selected from the group consisting of Ti, Ta, Cr, Mo, V, and Nb.

13. The method of claim 11, wherein the composition is selected from the group consisting of TiVNbMoC₃ and TiVCrMoC₃.

14. (canceled)

15. The method of claim 11, wherein preparing the high-entropy precursor MAX phase powder includes mixing and reactive sintering elemental powders of equimolar ratio of four transition metals M1, M2, M3, and M4 with Al and C M1:M2:M3:M4:Al:C in 1:1:1:1:1.1:2.7 stoichiometric ratio to obtain one or more sintered MAX phase blocks.

16. The method of claim 15, wherein preparing the high-entropy precursor MAX phase powder further includes milling the one or more sintered MAX phase blocks to obtain the high-entropy precursor MAX phase powder.

17. The method of claim 11, wherein etching the high-entropy precursor MAX phase powder includes adding the high-entropy precursor MAX phase powder into an aqueous hydrofluoric acid to selectively etch away Al to obtain the high-entropy multi-layered MXene powder.

18. The method of claim 11, wherein delaminating the high-entropy multi-layered MXene powder includes delaminating the high-entropy multi-layered MXene powder using tetramethylammonium hydroxide (TMAOH).

19. The method of claim 18, wherein delaminating the high-entropy multi-layered MXene powder further includes filtering the high-entropy multi-layered MXene from TMAOH to obtain the single-to-few-layered high-entropy two-dimensional carbide MXene flakes.

20. A composition of matter comprising a high-entropy two-dimensional carbide MXene having a general formula of M1M2M3M4AX₃, wherein:
X is carbon;
A is aluminum; and
M1, M2, M3, and M4 each represent a different transition metal selected from the group consisting of Ti, Ta, Sc, Cr, Zr, Mo, V, and Nb.
